(19) United States
(12) Patent Application Publication
(10) Pub. No.: US 2018/0111140 A1
(43) Pub. Date: Apr. 26, 2018

(54) SPRAY PROPORTIONER SYSTEM AND HOSES

(71) Applicant: Spray Polyurethane Parts, Inc., Panama City, FL (US)

(72) Inventor: Keith Miller, Panama City, FL (US)

(73) Assignee: Spray Polyurethane Parts, Inc., Panama City, FL (US)

(21) Appl. No.: 15/299,162

(22) Filed: Oct. 20, 2016

(51) Int. Cl. B05B 7/16; B05B 7/04; B05B 7/24; B01F 5/06

(52) U.S. Cl. CPC B05B 7/1693; B05B 7/0408; B01F 2005/0633; B05B 7/04; B01F 5/0615; B05B 7/24

(57) ABSTRACT

A spray proportioner hose includes an inner diameter that extends along a longitudinal length of the hose and through which a flow of spray component from a spray proportioner unit may be directed toward a fluid manifold of an applicator gun. At the fluid manifold, the spray component will be mixed with another spray component in a desired proportion. The hose includes a static mixer positioned within its inner diameter to interact with and thereby mix the flowed spray component within the inner diameter of the hose before the spray component is delivered to the fluid manifold.

### TECHNOLOGY

The present application is directed to spray proportioner systems. More specifically the present application is directed to hoses and components thereof for spray proportioner systems.

### BACKGROUND

Spray proportioners are used to deliver a proportioned stream of spray components and are commonly used for spraying insulation, polyurethane foam, and polyurea formulations. Spray proportioners generally include pumps that pump individual spray components to an applicator gun via hoses. Applicator guns generally include a fluid manifold where the spray components are delivered into from the hose and therein combined. Application guns may also include nozzles that combine the spray components in a combined stream created via the nozzles. In either instance, spray components are sprayed from the application gun in a combined stream.

### SUMMARY

In one aspect, a hose for use with a spray proportioner system includes a longitudinal length and a inner diameter that extends along the longitudinal length for directing a flow of a spray component from a spray proportioner unit toward a fluid manifold of an applicator gun wherein the spray component will be mixed with another spray component. The hose may also include a static mixer positioned within the inner diameter to interact with and thereby mix the flowed spray component within the inner diameter of the hose.

In various embodiments, the hose may include a whip hose, and the static mixer may be positioned within the inner diameter of the whip hose. In one embodiment, the hose may include one or more heated lengths. In one example, the static mixer may extend along at least one of the heated lengths. In one embodiment, the static mixer includes one or more helical mixer elements. For example, the hose may include a whip hose, and at least one of the one or more helical mixer elements may be positioned within the inner diameter of the whip hose. In another example, the helical mixer elements may include a spring positioned within the inner diameter. In another example, the helical mixer elements may include alternating right handed and left handed helical segments positioned within the inner diameter. In a further embodiment, the static mixer may extend 18 inches along the longitudinal length and comprise 3 of the helical segments per inch.

In another aspect, a spray proportioner system may include a spray proportioner unit that includes a first pump and a second pump. The first pump may pumping a first spray component along a first supply line between a supply of the first spray component to a fluid manifold of an applicator gun. The second pump may pump a second spray component along a second supply line between a supply of the second spray component to the fluid manifold of the applicator gun. The system may further include a first hose and a second hose. The first hose may have an inner diameter that extends along a longitudinal length of the first hose. The first hose may fluidically couple to the spray proportioner unit along the first supply line to receive the first spray component within its inner diameter from the spray proportioner unit and direct the first spray component toward the fluid manifold of the applicator gun. The second hose may have an inner diameter that extends along a longitudinal length of the second hose. The second hose may fluidically couple to the spray proportioner unit along the second supply line to receive the second spray component within its inner diameter from the spray proportioner unit and direct the second spray component toward the fluid manifold of the applicator gun. The system may further include a static mixer positioned within the inner diameter of at least one of the first hose or second hose to interact with and thereby mix the received first or second spray component within its inner diameter.

In various embodiments, the first hose, second hose, or both may include a whip hose, and the static mixer may be positioned within the inner diameter of the whip hose of at least one of the first hose or second hose. In one embodiment, the first hose, second hose, or both include one or more heated lengths. In one example, the static mixer is positioned within at least one of the one or more heated lengths. In one embodiment, the first static mixer, the second static mixer, or both include one or more helical mixer elements. In one example, the first hose, second hose, or both may include a whip hose. One or more of the helical mixing elements may be positioned within the inner diameter of the whip hose. In another example, the helical mixer elements include a spring positioned within the inner diameter of the respective first or second hose. In yet another embodiment, the helical mixer elements include alternating right handed and left handed helical segments positioned within the inner diameter of the respective first or second hose. In a further example, at least one of the first static mixer or second static mixer may extends 18 inches along the respective longitudinal length of the first or second hose and include 3 of the helical segments per inch. The spray proportioner unit may further include one or more heaters operable to heat the first spray component, second spray component, or both.

### BRIEF DESCRIPTION OF THE DRAWINGS

For a more complete understanding of the present disclosure and its features and advantages, reference is now made to the following description, taken in conjunction with the accompanying drawings, in which:

FIG. 1 schematically illustrates a spray proportioner system according to various embodiments described herein;

FIG. 2A is a cross-section of a hose having a static mixer according to various embodiments described herein;

FIG. 2B is a cross-section of a hose having a static mixer according to various embodiments described herein; and

FIG. 3 illustrates a hose comprising an add-on hose having a static mixer according to various embodiments described herein.

### DESCRIPTION

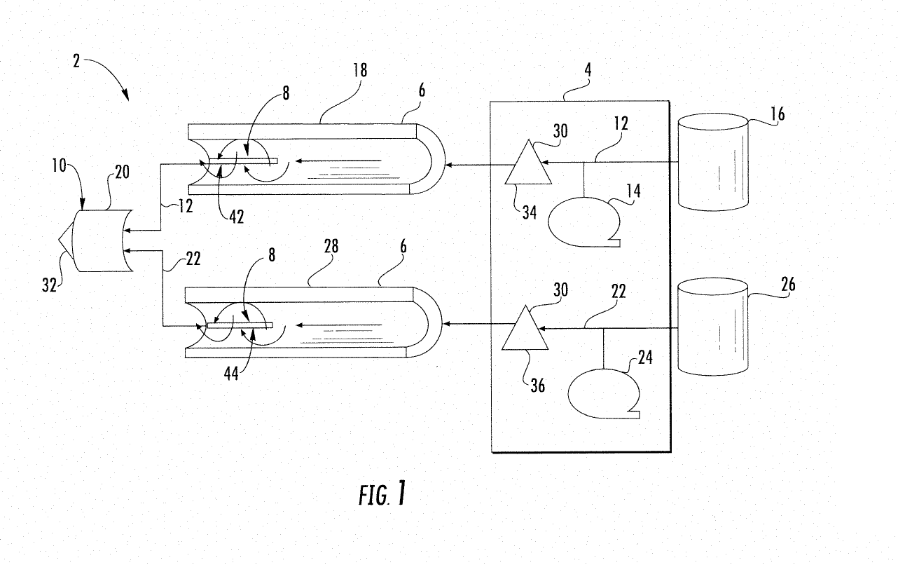

Spray proportioner systems including static mixing hoses, static mixing hoses for spray proportioner systems, and components of static mixing hoses for spray proportioner systems are described below with reference to FIGS. 1-3, wherein like numerals indicated like features.

With reference to FIG. 1, a spray proportioner system 2 may include a spray proportioner unit 4 operable to proportion a first and second spray component and two or more hoses 6 at least one comprising a static mixer 8, to deliver a respective spray component to an applicator gun 10. In particular, the spray proportioner system 2 may include a first supply line 12 operatively coupled to a first pump 14 of the spray proportioner unit 4. The first supply line 12 may fluidically couple to a supply of the first spray component 16 and the first pump 14 may pump the first spray component from the supply of the first spray component 16 through the unit 4 to a hose 6, which may also be referred to as first hose 18. The first pump 14 may further pump the first spray component through the first hose 18 to a fluid manifold 20. The spray proportioner system 2 may include a second supply line 22 operatively coupled to a second pump 24 of the spray proportioner unit 4. The second supply line 22 may fluidically couple to a supply of the second spray component 26 and the second pump 24 may pump the second spray component from the supply of the second spray component 26 through the unit 4 to a hose 6, which may also be referred to as second hose 28. The second pump 24 may further pump the second spray component through the second hose 18 to the fluid manifold 20.

5

The spray proportioner system 2 may further include the applicator gun 10. In various embodiments, the fluid manifold 20 may include or fluidically couple to the applicator gun 10. In operation, the first and second spray components are combined in the fluid manifold 20 and sprayed from the applicator gun 10 in a combined stream. In one embodiment, the fluid manifold 20 comprises a mixing chamber into which the respective hoses 18, 28 deliver each of the first and second spray components. In one embodiment, the fluid manifold 20 comprises one or more nozzles 32 to which the respective hoses 18, 28 deliver each of the first and second spray components and through which the first and second spray components are mixed upon being sprayed from the nozzles 32.

It will be appreciated that, in some embodiments, the first pump 14 may include multiple pumps operatively coupled to the first supply line 12 at one or more points. In these or other embodiments, the second pump 24 may include multiple pumps operatively coupled to the second supply line 22 at one or more points. The first pump 14 and second pump 24 may flow the spray components through the respective supply lines 12, 22 of the spray proportioner system 2 at high pressures, such as between 1000 psi to 2000 psi or greater.

The spray proportioner system 2 may further include one or more heaters 30. As shown, the spray proportioner system 2 includes one or more heaters 30 comprising a first heater 34 operatively coupled to the first supply line 12 to heat the first spray component and a second heater 36 operatively coupled to the second supply line 22 to heat the second component. While illustrated as a component of the spray proportioner unit 4, in various embodiments, the first heater 34, second heater 36, or both may include heaters associated with the supply of spray components 16, 26, the hoses 18, 28, or both. In some embodiments, the first heater 34 includes multiple heaters operatively coupled to the first supply line 12 at one or more points. In these or other embodiments, the second heater 36 may include multiple heaters operatively coupled to the second supply line 22 at one or more points. In some embodiments, the first heater 34, second heater 36, or both may include pre-heaters that heat the respective spray components prior to the spray components exiting the spray proportioner unit 4 and entering the hoses 18, 28. In these or other embodiments, the first hose 18, second hose 28, or both may be heated hoses including one or more heated sections. In one such example, one or both of the first and second hoses 18, 28 are heated hoses and include heating elements that extend along the flow paths within the inner diameter of the first and second heated hoses 18, 28. In another embodiment, not shown, the spray proportioner system 2 does not include a heater 34, 36.

As introduced above, the spray proportioner system 2 may also include one or more static mixers 8 positioned within a hose 6, such as one or both of the first hose 16 or second hose 26, to mix a spray component while the spray component is flowed therethrough. A spray proportioner hose 6 typically has an inner diameter of ⅜ inch or ½ inch along the majority of its length. The hose 6 may include various hose sections, some of which may be add-on hoses that extend a length of main hose. An add-on hose, for example, may couple to main hoses having shorter or longer lengths. Add-on hoses may comprise extensions, heated sections, or a whip hose, for example. Whip hoses typically have inner diameters of ¼ inch or ⅜ inch and are shorter than the main hose to which they couple. The inner diameter of the whip hose may be less than the main hose to which it couples. In various embodiments, a static mixer 6, such as the first static mixer 42, second static mixer 44, or both, are positioned in one or more of a main hose or add-on hose.

As described in more detail below, a static mixer 8 may include structures located within the inner diameter of the hose 6 that partially obstruct the flow path to cause swirling or other turbulent flow characteristics within the flow of the spray component to mix the spray component. The mixing of a particular spray component provided by the static mixer 8 may improve uniformity of that spray component prior to mixing with the other spray component. For example, the static mixer 8 may decrease chemical instability, layer formation/phase separation, or enhance thermal uniformity of the spray component. As shown, the spray proportioner system 2 includes a first static mixer 42 along the first hose 18 and a second static mixer 44 along the second hose 28. Thus, in various embodiments, at least one of the first hose 18 or the second hose 28 may include a static mixer 8 that provides intracomponent mixing of a spray component within the hose 18, 28 before the spray component is combined with the other spray component at the fluid manifold 20. The static mixers 42, 44 are shown located toward an end of each hose 18, 28, adjacent to the fluid manifold; however, in some embodiments, one or both of the hoses 18, 28 include a static mixer 42, 44 or portion thereof at one or more other locations, such as the end adjacent to the spray proportioner unit 4 or one or more lengths of the hose 18, 28 between the two ends.

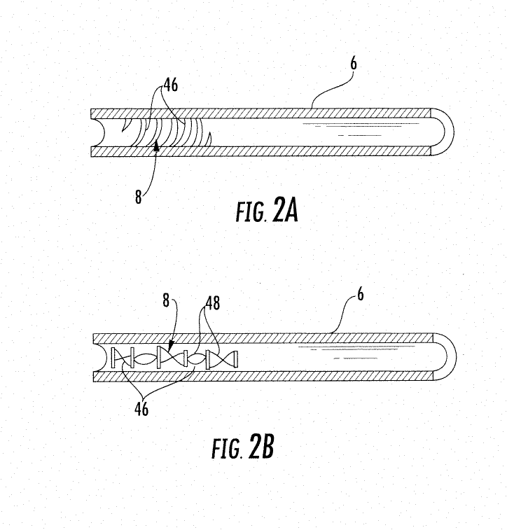

FIGS. 2A & 2B illustrate two embodiments of hoses 6 for a spray proportioner system, such as spray proportioner system 2, that include a static mixer 8. Each static mixer 8 is positioned along a length of the hose 6, which may be similar to hoses 18, 28 or portions thereof, to mix a spray component within the inner diameter of the hose 6 while the spray component is flowed therethrough. As introduced above, the static mixer 8 may be structured to obstruct a portion of a flow path (inner diameter of the hose 6) causing turbulence or flow patterns that enhance mixing of the spray component. Specifically, a static mixer 8 may include mixer elements 46 structured to direct/redirect portions of the flowing spray component. As such, mixer elements 46 may alter local flow velocities/direction vectors, flow patterns, etc. to aid in mixing. For example, in some embodiments, mixer elements 46 may divide portions of the flow. In further embodiments, mixer elements 46 may induce crossing patterns, e.g., mixer elements 46 may direct divided flows to cross to enhance mixing. In a further or another embodiment, the mixer elements 46 may include surfaces or edges angled with respect to the flow path to create local vortices within the divided portions, crossed flows, radial mixing, or larger swirling flow patterns along one or more lengths of the hose. In various embodiments, mixer elements 46 may include baffles or helixes. Baffles, helixes, or other mixer elements 46 may include angled surfaces, projections, ribs, vanes, fins, grooves, lips, and other structures for interacting with flow.

Mixer elements 46 may be located along central portions of the inner diameter of the hose 6, along peripheral portions of the inner diameter of the hose 6, or both. For example, in one embodiment, a static mixer 8 includes mixer elements 46 comprising grooves or raised protrusions extending from the periphery, e.g., wall, of the inner diameter of the hose 6. The protrusions may act as bafflers to divide or direct/redirect flow. In some embodiments, peripherally located mixer elements 46 may direct/redirect peripheral flows away from the periphery, e.g., toward central portions, which may include centrally located mixer elements 46 to divide or cause swirl patterns, or redirect flows along the periphery, e.g., to cause swirl patterns, vortices, or turbulence. FIG. 2A illustrates one example of a static mixer 8 including a helical configuration around a periphery of an inner diameter of the hose 6, similar to a spring. The helical mixer elements 46 may be formed by positioning of a helical member or spring within the inner diameter or may be formed in the wall, e.g., by grooves or protrusions.

In certain embodiments, centrally located mixer elements may direct flows to the peripheries of the inner diameter of the hose 6, e.g., along or against walls of the hose, which, in one embodiment, may include peripherally located mixer elements 46. In some embodiments, mixer elements 46 may be both peripherally and centrally positioned. For example, a static mixer 8 may include a mixer element 46 that extends from a central portion of the inner diameter to a periphery or adjacent thereto. FIG. 2B illustrates an example of a static mixer 8 that extends along the central and peripheral portions of the inner diameter of the hose 6 to divide the flow. The static mixer 8 includes mixer elements 46 comprising a plurality of segments 48, each defining a helix. As shown, the segments 48 alternate between right and left handed helixes. In other embodiments, a single right or left handed helix may be used. The configuration of the static mixer may produce crossing patterns, radial flows, or other turbulences. Segments 48 may be of similar or different lengths. In various embodiments, each inch of the static mixer 8 may include 1 to 5 segments 48, for example.

In another embodiment (not shown), a static mixer 8 may include a mixing element 46 comprising a matrix of baffles presenting a variety of angled surfaces to the direction of flow. The static mixer 8 may also include a mixer element 46 that extends from a periphery to a central portion of the inner diameter or across the inner diameter or flow path between two peripheries, e.g., separating the flow of spray component into separate flows along a portion of the inner diameter or flow path. For example, a static mixer 8 may comprise a series of baffles that extend across the inner diameter at one or more positions along the hose 6 to divide or direct/redirect flows to drive mixing.

In one embodiment, a hose 6 illustrated in FIGS. 1-2B includes between 8 inches and 30 inches of the static mixer 8, such as a spring or alternating helixes (see, e.g., FIGS. 2A & 2B) per 200 feet of hose 6. In one example, each inch of static mixer 8 may include 3 segments 48 of alternating helixes (see, e.g., FIG. 2B). In a further example, 18 inches of the static mixer 8 may be located within a 300 to 400 foot length of hose. The inner diameter of the hose 6 may be between ¼ inch and ½ inch.

With reference again to the spray proportion system 2 shown in FIG. 1, the first static mixer 42 and second static mixer 44 are shown generally but may include mixing elements configured for static mixing, e.g., as described herein with respect to FIGS. 2A & 2B. The first static mixer 42 and second static mixer 44 may include the same or different configurations of mixing elements. The first static mixer 42 and second static mixer 44 may extend along a same or different length of their respective hose 18, 28. One or both of the first static mixer 42 or second static mixer 44 may extend along multiple lengths of their respective hose 18, 28. Thus, the length(s) and location(s) of the first and second static mixers 42, 44 may be customized to provide optimal mixing of a particular spray component, e.g., in consideration of the characteristics or tendency of the spray component to become unstable.

With continued reference to FIGS. 1-2B, a static mixer 8 may be integrated with the hose 6 within the inner diameter. For example, in some embodiments, the static mixer 8 may be integral with the hose 6 such that the static mixer 8 is integrated with the hose 6 during manufacturing. In certain embodiments, the static mixer 8 may include an insert that may be inserted into the inner diameter of a hose 6 or portion thereof. The insert may be part of a kit used to retrofit a hose 6 with the static mixer 8.

Hoses 6 equipped with static mixers 8 may be of a variety of lengths and may comprise a main spray proportioner hoses or add-on hoses that may be coupled with the main hose. In one embodiment, a hose 6 comprising a static mixer 8 includes a hose segment having a coupling at each end that may be coupled to another hose to thereby extend the length of the hose 6. The couplings may couple the segment between two hoses, a hose and the fluid manifold 20, or a hose connection at spray proportioner unit 4, such as a recirculation manifold, and a hose, for example.

In various embodiments, a static mixer 8 may be located within a length of main hose, an add-on hose having the same or different inner diameter, or both. Thus, the hoses illustrated in FIGS. 2A & 2B may include main hoses or an add-on hoses, such as whip hoses, that include a static mixer 8 or portion thereof.

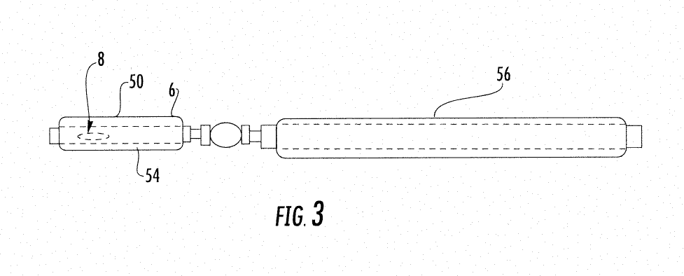

FIG. 3 illustrates an embodiment of a hose 6 for a spray proportioner system including a static mixer 8 including mixer elements (not shown), as described herein, along an add-on hose 50 coupled to or coupleable to one or more additional hose lengths, generally referred to herein as a main hose 52. For example, the add-on hose 50 may be a length of hose, e.g., 2 to 100 feet, including a static mixer 8 as described herein and configured to couple to one or more additional lengths hose between a spray proportioner unit 4 and fluid manifold 20 (see, e.g., FIG. 1). In the illustrated embodiment, the add-on hose 50 is a length of whip hose 54. In other embodiments, the add-on hose 50 may not be a whip hose 54. The whip hose 54 may be of traditional length, e.g., between 2 feet and 15 feet, such as 3 feet, 6 feet, or 10 feet. The whip hose 54 may be coupled or couplable between a length of main hose 52 and the fluid manifold 20. The main hose 52 may have a length of between 100 feet and 500 feet, such as 300 feet. In one such embodiment, the whip hose 54 has an inner diameter of ¼ inch and the main hose 52 has an inner diameter of ⅜ inch.

In various embodiments, any hose 6 described herein, e.g., hoses 18, 28, 50, comprising a static mixer 8 may be a heated hose or may couple to a heated hose. In various embodiments, a static mixer 8 may also be located anywhere along the length of a hose 6. For example, a static mixer 8 may be located along an end portion or central portion of the length of the hose 6. In some embodiments, a hose 6 includes multiple lengths that include a static mixer 8. For example, a hose 6 may include a length of static mixer 8 at 100 feet and 250 feet, 200 feet and 300 feet, every 100 feet, every 150 feet, every 200 feet, every 300, every 100 feet after 50 feet, every 100 feet after 200 feet, or as otherwise needed. One or more static mixers 8 comprising add-on hose sections may be coupled to additional lengths of hose to customize static mixer locations. In various embodiments, a static mixer 8 comprising a whip hose may be coupled between a main hose and a fluid manifold 20.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an application of the described embodiments. Further, the use of a singular noun includes the plural, and the use of a plural noun includes the singular, unless the context of the usage requires otherwise. Additionally, the grammatical conjunctions “and” and “or” are used herein according to accepted usage. By way of example, “x and y” refers to “x” and “y”. On the other hand, “x or y” refers to “x”, “y”, or both “x” and “y”, whereas “either x or y” refers to exclusivity.

This disclosure describes various elements, features, aspects, and advantages of various embodiments, configurations, and arrangements of a spray proportioner system, components for use with a spray proportioner system, and methods thereof. It is to be understood that certain descriptions of the various embodiments and such configurations and arrangements thereof have been simplified to illustrate only those elements, features and aspects that are relevant to a more clear understanding of the disclosed embodiments, while eliminating, for purposes of brevity or clarity, other elements, features and aspects. Any references to “various,” “certain,” “some,” “one,” or “an” when followed by “embodiment,” “configuration,” or “arrangement” generally means that a particular element, feature or aspect described in the example is included in at least one embodiment. The phrases “in various,” “in certain,” “in some,” “in one,” or “in an” when followed by “embodiment”, “configuration”, or “arrangement” may not necessarily refer to the same embodiment. Furthermore, the phrases “in one such” or “in this” when followed by “embodiment,” “configuration,” or “arrangement,” while generally referring to and elaborating upon a preceding embodiment, is not intended to suggest that the elements, features, and aspects of the embodiment introduced by the phrase are limited to the preceding embodiment; rather, the phrase is provided to assist the reader in understanding the various elements, features, and aspects disclosed herein and it is to be understood that those having ordinary skill in the art will recognize that such elements, features, and aspects presented in the introduced embodiment may be applied in combination with other various combinations and sub-combinations of the elements, features, and aspects presented in the disclosed embodiments. It is to be appreciated that persons having ordinary skill in the art, upon considering the descriptions herein, will recognize that various combinations or sub-combinations of the various embodiments and other elements, features, and aspects may be desirable in particular implementations or applications. However, because such other elements, features, and aspects may be readily ascertained by persons having ordinary skill in the art upon considering the description herein, and are not necessary for a complete understanding of the disclosed embodiments, a description of such elements, features, and aspects may not be provided. For example, ovens and oven systems described herein may also include connections such as fittings for one or more of electrical connections, gas connections, or flue connections. As such, it is to be understood that the description set forth herein is merely exemplary and illustrative of the disclosed embodiments and is not intended to limit the scope of the invention as defined solely by the claims.

1. A hose for use with a spray proportioner system, the hose comprising:
a longitudinal length;
a inner diameter extending along the longitudinal length for directing a flow of a spray component from a spray proportioner unit toward a fluid manifold of an applicator gun wherein the spray component will be mixed with another spray component;
a static mixer positioned within the inner diameter to interact with and thereby mix the flowed spray component within the inner diameter of the hose.

2. The hose of claim 1, wherein the hose comprises a whip hose and the static mixer is positioned within the inner diameter of the whip hose.

3. The hose of claim 1, wherein the hose includes one or more heated lengths.

4. The hose of claim 3, wherein the static mixer extends along at least one of the heated lengths.

5. The hose of claim 1, wherein the static mixer comprises one or more helical mixer elements.

6. The hose of claim 5, wherein the hose comprises a whip hose, and wherein at least one of the one or more helical mixer elements are positioned within the inner diameter of the whip hose.

7. The hose of claim 5, wherein the helical mixer elements comprise a spring positioned within the inner diameter.

8. The hose of claim 5, wherein the helical mixer elements comprise alternating right handed and left handed helical segments positioned within the inner diameter.

9. The hose of claim 8, wherein the static mixer extends 18 inches along the longitudinal length and comprises 3 of the helical segments per inch.

10. A spray proportioner system, the system comprising:
a spray proportioner unit comprising
a first pump for pumping a first spray component along a first supply line between a supply of the first spray component to a fluid manifold of an applicator gun, and
a second pump for pumping a second spray component along a second supply line between a supply of the second spray component to the fluid manifold of the applicator gun;
a first hose having an inner diameter extending along a longitudinal length of the first hose, the first hose fluidically coupled to the spray proportioner unit along the first supply line to receive the first spray component within its inner diameter from the spray proportioner unit and direct the first spray component toward the fluid manifold of the applicator gun;
a second hose having an inner diameter extending along a longitudinal length of the second hose, the second hose fluidically coupled to the spray proportioner unit along the second supply line to receive the second spray component within its inner diameter from the spray proportioner unit and direct the second spray component toward the fluid manifold of the applicator gun;
a static mixer positioned within the inner diameter of at least one of the first hose or second hose to interact with and thereby mix the received first or second spray component within its inner diameter.

11. The system of claim 10, wherein the first hose, second hose, or both include a whip hose, and wherein the static mixer is positioned within the inner diameter of the whip hose of at least one of the first hose or second hose.

12. The system of claim 10, wherein the first hose, second hose, or both include one or more heated lengths.

13. The system of claim 12, wherein the static mixer is positioned within at least one of the one or more heated lengths.

14. The system of claim 10, wherein the first static mixer, the second static mixer, or both comprises one or more helical mixer elements.

15. The system of claim 14, wherein the first hose, second hose, or both include a whip hose, and wherein one or more of the helical mixing elements are positioned within the inner diameter of the whip hose.

16. The system of claim 14, wherein the helical mixer elements comprise a spring positioned within the inner diameter of the respective first or second hose.

17. The system of claim 14, wherein the helical mixer elements comprise alternating right handed and left handed helical segments positioned within the inner diameter of the respective first or second hose.

18. The system of claim 17, wherein at least one of the first static mixer or second static mixer extends 18 inches along the respective longitudinal length of the first or second hose and comprises 3 of the helical segments per inch.

19. The system of claim 11, wherein the spray proportioner unit comprises one or more heaters configured to heat at the first spray component, second spray component or both as the spray component is pumped along the respective first or second supply line.
